(19) United States
(12) Patent Application Publication
(10) Pub. No.: US 2012/0308971 A1
(43) Pub. Date: Dec. 6, 2012

(54) EMOTION RECOGNITION-BASED BODYGUARD SYSTEM, EMOTION RECOGNITION DEVICE, IMAGE AND SENSOR CONTROL APPARATUS, PERSONAL PROTECTION MANAGEMENT APPARATUS, AND CONTROL METHODS THEREOF

(76) Inventors: Hyun Soon SHIN, Daejeon (KR); Jun Jo, Daejeon (KR); Yong Kwi Lee, Daejeon (KR); YunKyung Lee, Daejeon (KR)

(21) Appl. No.: 13/484,860

(22) Filed: May 31, 2012

(30) Foreign Application Priority Data
May 31, 2011 (KR) 10-2011-0051857
Nov. 21, 2011 (KR) 10-2011-0121599

(51) Int. Cl. G09B 19/00

(52) U.S. Cl. 434/236

(57) ABSTRACT

An emotion recognition device includes a user interface configured to display input-related menus and receive a control command; and a sensing unit configured to sense a bio-signal of a user or a surrounding environment signal of the user using at least one sensor. Further, the emotion recognition device includes an emotion recognition management unit configured to determine based on the sensed signal whether a transition to a danger emotional signal or a criminal emotional signal for the user has occurred, and then requesting tracking emotion recognition. Furthermore, the emotion recognition device includes a dangerous and criminal situation action unit configured to request emotion recognition handling of a dangerous or criminal situation depending on a danger or criminal emotion.

### CROSS-REFERENCE TO RELATED APPLICATIONS

The present invention claims priority of Korean Patent Application No. 10-2011-0051857, filed on May 31, 2011, and Korean Patent Application No. 10-2011-0121599, filed on Nov. 21, 2011, which are incorporated herein by references.

### FIELD OF THE INVENTION

The present invention relates generally to personal protection technology based on emotional awareness; and more particularly, to an emotion recognition-based bodyguard system, an emotion recognition device, an image and sensor control apparatus, a personal protection management apparatus, and control methods thereof, which are suitable for recognizing the danger emotion or criminal emotion of a person and then protecting the safety of persons based on the recognized danger emotion or criminal emotion.

### BACKGROUND OF THE INVENTION

Recently, as sexual crimes committed against children have become a great issue, safety notification services using mobile phones or the like have been used more and more, and the demand for strengthening surveillance systems for sexual criminals has increased. However, at the present time, technologies for preventing such crimes, automatically reporting crimes, or implementing self-protection against crimes have not yet been proposed.

In particular, in the case of child- and woman-related sexual crimes or kidnapping cases that have recently become a social issue, methods are required for predicting and preventing the occurrence of a dangerous situation or a criminal situation before they happen using technology that automatically recognizes the emotion of danger felt by victims or the criminal emotions felt by criminals and that copes with crimes.

As described above, conventional personal protection schemes are problematic because a user needs to use an SOS service by pressing buttons set in a mobile phone or use self-defense gadgets or the like capable of providing a warning against a danger, so that the schemes are useless when the user is disconcerted or cannot take the action of protecting oneself in a dangerous situation and a criminal situation in which a crime is being committed.

### SUMMARY OF THE INVENTION

In view of the above, the present invention provides an emotion recognition-based bodyguard system, an emotion recognition device, an image and sensor control apparatus, a personal protection management apparatus, and control methods thereof, which is capable of automatically recognizing the danger emotion and the criminal emotion of human beings, thus preventing the occurrence of a dangerous or criminal situation.

Further, the present invention provides an emotion recognition-based bodyguard system, an emotion recognition device, an image and sensor control apparatus, a personal protection management apparatus, and control methods thereof, which is capable of preventing and automatically handling a dangerous or criminal situation via the control of and interworking with a bodyguard device, smart Closed Circuit Televisions (CCTVs), and the personal protection management device. The bodyguard device is capable of recognizing a danger emotion and a criminal emotion based on both emotional signal awareness information, obtained by sensing bio-signals formed during the reaction of a human being's autonomic nervous system, and context awareness information, obtained by sensing environment signals, and that is capable of controlling the smart CCTVs and operating in conjunction with the smart CCTVs based on the recognized danger and criminal emotions.

In accordance with a first aspect of the present invention, there is provided an emotion recognition device including: a user interface configured to display input-related menus and receive a control command; a sensing unit configured to sense a bio-signal of a user or a surrounding environment signal of the user using at least one sensor; an emotion recognition management unit configured to determine based on the sensed signal whether a transition to a danger emotional signal or a criminal emotional signal for the user has occurred, and then requesting tracking emotion recognition; and a dangerous and criminal situation action unit configured to request emotion recognition handling of a dangerous or criminal situation depending on a danger or criminal emotion.

In accordance with a second aspect of the present invention, there is provided an image and sensor control apparatus including: an interworking unit configured to receive an object tracking request message emotion recognition; a sensing unit configured to recognize an image of an object requested to be tracked, sense a surrounding environment and track a location of the object; and a processing unit configured to transmit the recognized image, sensed surrounding environment information, and location tracking information emotion recognition.

In accordance with a third aspect of the present invention, there is provided a personal protection management apparatus including: an emotion recognition device interworking unit configured to interwork with the emotion recognition device which senses a bio-signal and a surrounding environment signal and recognizes danger and criminal emotions; an image and sensor control apparatus interworking unit configured to interwork with an emotion recognition device which aggregates image and location information by tracking an object requested by the emotion recognition device; a current situation/location management and monitoring unit configured to, when receiving information about the object from the emotion recognition device and the image and sensor control apparatus, analyze the received information and execute danger and criminal emotion recognition algorithms; and an emergency action unit configured to, if it is determined as a result of the analysis that a danger or criminal emotion has been recognized, send a message requesting generation of a warning sound to the emotion recognition device and transmit a request for an emergency of the object to a department which controls dangers and crimes.

In accordance with a fourth aspect of the present invention, there is provided an emotion recognition-based bodyguard system including: an emotion recognition device configured to receive an emotional signal by sensing a bio-signal of a user and to receive context information by sensing a surrounding environment signal of the user, thus determining whether a danger emotion and a criminal emotion have been recognized based on a threshold; an image and sensor control apparatus configured to, upon receiving an object tracking request from the emotion recognition device which operates in conjunction with the image and sensor control apparatus, sense an image signal and surrounding environment information, track a relevant object based on location information of the relevant object, and transmit tracking-related information about the relevant object to the emotion recognition device; and a personal protection management apparatus configured to receive a message requesting management and handle situations in conjunction with the emotion recognition device and the image and sensor control apparatus, analyze information about the relevant object, and, if it is determined that a danger emotion or a criminal emotion has been recognized, report a current situation to an emergency response department, perform tracking a location of the relevant object, and monitoring the object.

In accordance with a fifth aspect of the present invention, there is provided a method for controlling an emotion recognition device, including: sensing, by a sensing unit, a bio-signal of a user or a surrounding environment signal of the user using at least one sensor; determining, by an emotion recognition management unit, whether a transition to a danger emotional signal or a criminal emotional signal for the user has occurred, based on the sensed signal, and then sending a tracking request message emotion recognition; and sending, by an action unit, a message requesting handling of a dangerous or criminal situation emotion recognition.

In accordance with a sixth aspect of the present invention, there is provided a method for controlling an image and sensor control apparatus, including: receiving, by an interworking unit, an object tracking request message emotion recognition and recognizing danger and criminal emotions; recognizing, by a sensing unit, an image of an object requested to be tracked, sensing a surrounding environment and tracking a location of the object; and transmitting, by a processing unit, the recognized image, sensed surrounding environment information, and location tracking information emotion recognition.

In accordance with a seventh aspect of the present invention, there is provided a method for personal protection management apparatus, including: operating, by an interworking unit, in conjunction with an emotion recognition device which senses a bio-signal and a surrounding environment signal and recognizes danger and criminal emotions, and an image and sensor control apparatus which aggregates image and location information by tracking an object requested by the emotion recognition device; when information about the object is received from the emotion recognition device and the image and sensor control apparatus, analyzing, by a monitoring unit, the received information and executing danger and criminal emotion recognition algorithms; and if it is determined as a result of the analysis that a danger or criminal emotion has been recognized, sending, by an emergency action unit, a message requesting generation of a warning sound to the emotion recognition device and transmitting a request for an emergency of the object to a department which controls dangers and crimes.

In accordance with an eighth aspect of the present invention, there is provided an emotion recognition-based bodyguard method, including: receiving, by an emotion recognition device, an emotional signal by sensing a bio-signal of a user; receiving context information by sensing a surrounding environment signal of the user; determining whether a danger emotion and a criminal emotion have been recognized based on a threshold; when receiving an object tracking request from the emotion recognition device which operates in conjunction with an image and sensor control apparatus, sensing, by the image and sensor control apparatus, an image signal and surrounding environment information; tracking a relevant object based on location information of the relevant object, and transmitting tracking-related information about the relevant object to the emotion recognition device; receiving, by a personal protection management apparatus, a message requesting management and handling of situations in conjunction with the emotion recognition device and the image and sensor control apparatus; analyzing information about the relevant object, and, if it is determined that a danger emotion or a criminal emotion has been recognized, reporting a current situation to an emergency response department; and tracking a location of the relevant object and monitoring the object.

In accordance with an embodiment of the present invention, an automated protection/monitoring system is implemented by the application of emotion recognition technology, thereby helping to prevent and solve crimes. Further, the cases where the elderly and the infirm or women are thrown into psychological confusion and can neither suitably handle dangerous situations nor handle such a situation for themselves due to the occurrence of a sudden physical abnormality can be automatically sensed, so that help can be automatically asked for, thus allowing the users to provide countermeasures in an emergency and to enjoy physiological peace when there is no emergency.

Further, the present invention can continuously check the mental states of ex-convicts having the high possibility of secondarily committing a crime, or persons on probation, thus detecting or preventing the reoccurrence of impulsive or accidental crimes. Furthermore, the present invention allows some sexual criminals having psychiatric problems such as sexual perversion, among sexual criminals, to receive psychological treatment or to control themselves using a service that allows them to monitor their states and provides a warning or information to themselves using an alarm.

In particular, the advantage of improving the quality of life and promoting welfare can be predicted by providing the present invention to persons who have difficulty in normally communicating with other persons as a means to transmit their dangerous situations or emergencies to other persons.

### BRIEF DESCRIPTION OF THE DRAWINGS

The objects and features of the present invention will become apparent from the following description of preferred embodiments given in conjunction with the accompanying drawings, in which:

FIG. 1 is a block diagram briefly showing the configuration of an emotion recognition-based bodyguard system in accordance with an embodiment of the present invention;

FIGS. 2A to 2C are block diagrams showing the detailed configuration of an emotion recognition device in accordance with an embodiment of the present invention;

FIG. 3 is a block diagram showing the detailed configuration of an image and sensor control apparatus in accordance with an embodiment of the present invention;

FIG. 4 is a block diagram showing the detailed configuration of a personal protection management apparatus in accordance with an embodiment of the present invention;

FIGS. 5A to 8B are flow charts showing the operating procedure of the emotion recognition device in accordance with an embodiment of the present invention;

FIGS. 9A and 9B are flow charts showing the operating procedure of the image and sensor control apparatus in accordance with an embodiment of the present invention; and

FIGS. 10A and 10B are flow charts showing the operating procedure of the personal protection management apparatus in accordance with an embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described in detail with reference to the accompanying drawings which form a part hereof.

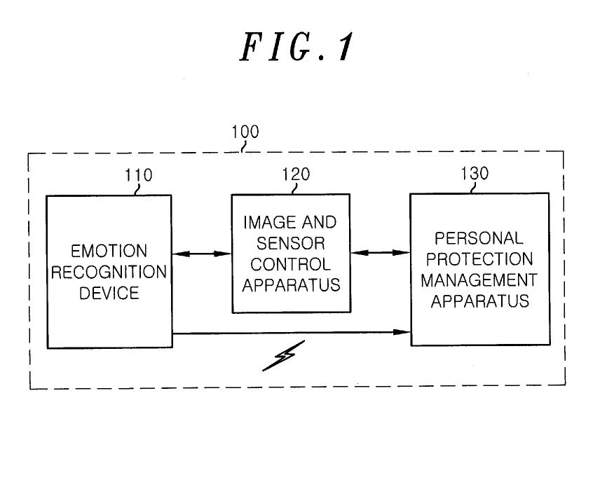

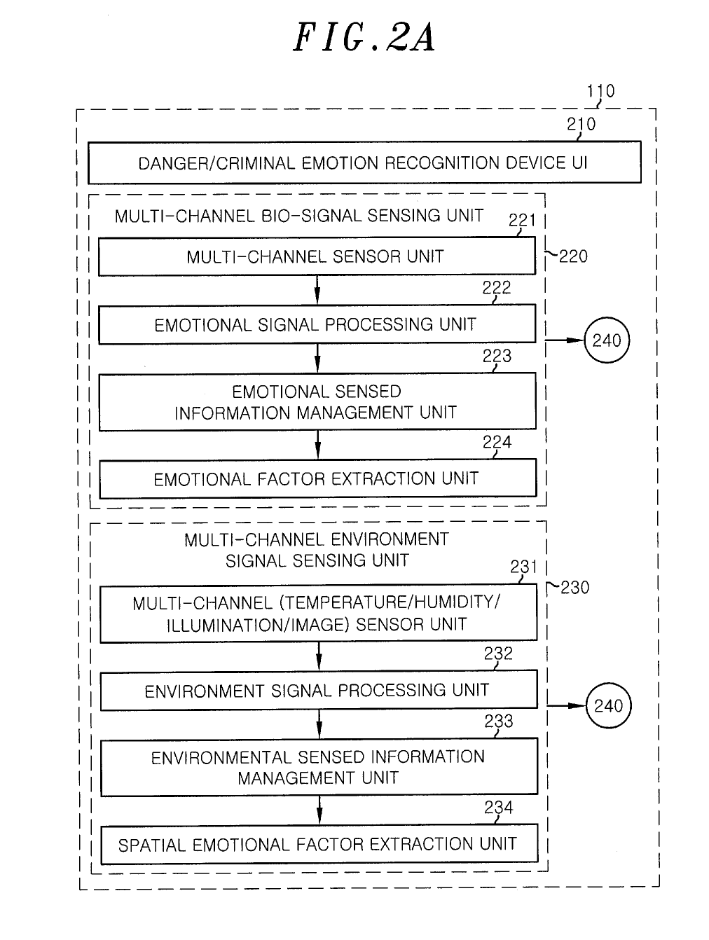

FIG. 1 is a block diagram briefly showing the configuration of an emotion recognition-based bodyguard system in accordance with an embodiment of the present invention.

Referring to FIG. 1, an emotion recognition-based bodyguard system 100 includes an emotion recognition device 110, an image and sensor control apparatus 120, and a personal protection management apparatus 130. The emotion recognition device 110 recognizes the danger and criminal emotions. The image and sensor control apparatus 120 is implemented as a smart CCTV and is configured to sense image and environment information about an object being tracked in conjunction with the emotion recognition device 110 and provide the sensed information both to the emotion recognition device 110 and to the personal protection management apparatus 130. The personal protection management apparatus 130 performs the function of taking action in the event of and handle situations in conjunction with the emotion recognition device 110 and the image and sensor control apparatus 120.

The emotion recognition device 110, the image and sensor control apparatus 120, and the personal protection management apparatus 130 may be operated in conjunction with one another via preset wired/wireless communication schemes, respectively. For example, as wired/wireless network communication means, the Internet based on a Transmission Control Protocol/Internet Protocol (TCP/IP) and a mobile communication network such as Wideband Code Division Multiple Access (WCDMA) and Wireless Broadband (WiBro) may be used. As Local Area Network (LAN) communication means, a local area network communication scheme such as a wireless LAN, Bluetooth, Near Field Communication (NFC), Radio Frequency Identification (RFID), Ultra-Wideband (UWB), and Zigbee may be used.

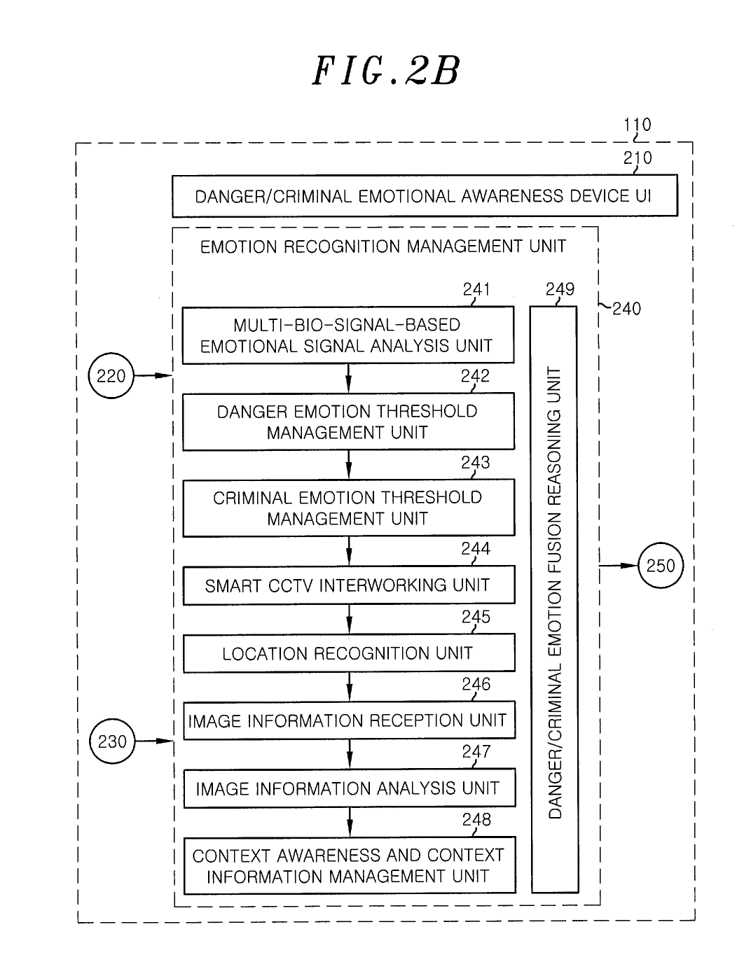

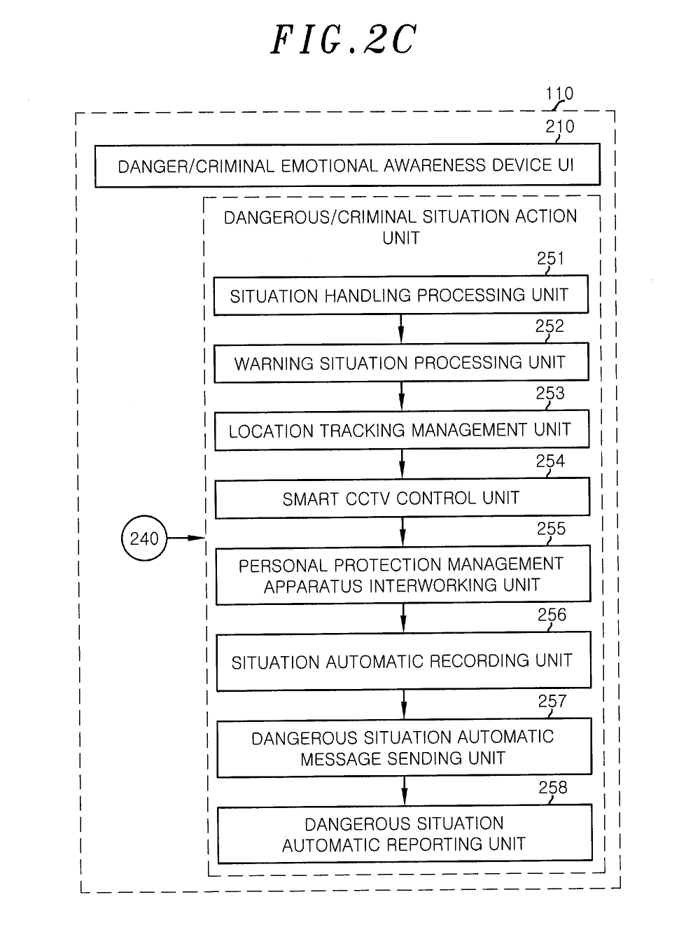

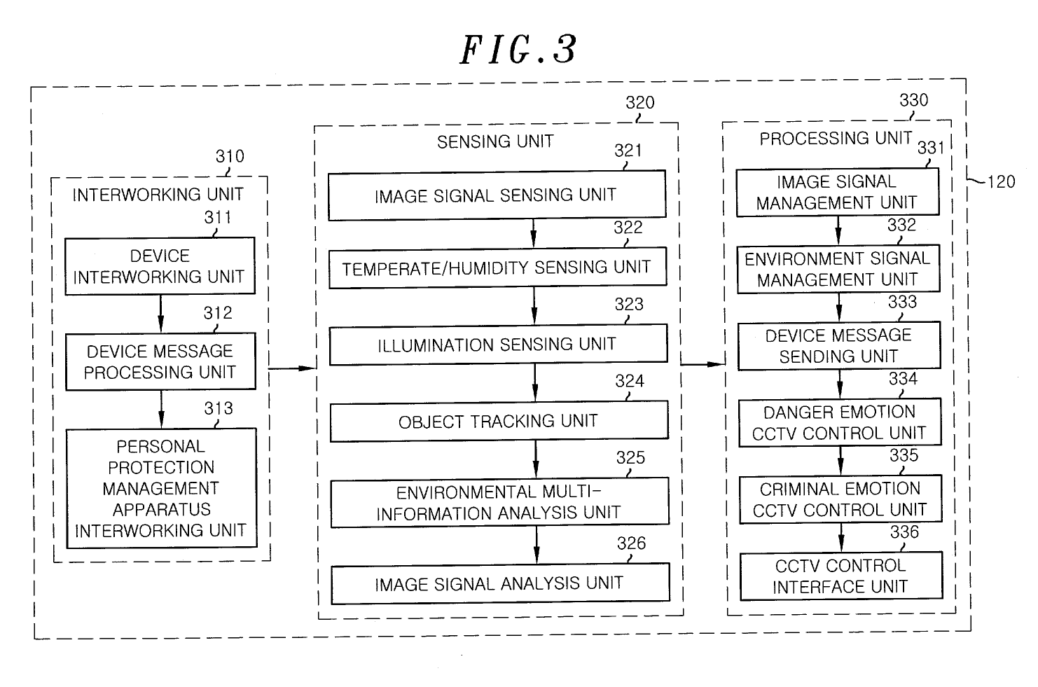

FIGS. 2A to 2C are block diagrams showing the detailed configuration of an emotion recognition device in accordance with an embodiment of the present invention.

Referring to FIGS. 2A to 2C, the emotion recognition device 110 includes a danger/criminal emotion recognition device User Interface (UI) 210, a multi-channel bio-signal sensing unit 220, a multi-channel environment signal sensing unit 230, an emotion recognition management unit 240, a dangerous/criminal situation action unit 250, and the like.

The danger/criminal emotion recognition device UI 210 detects and obtains a command input from a user via a keypad or in a touch screen manner, and displays menus required to manipulate the system, information related to a current emotional state, or the like.

The multi-channel bio-signal sensing unit 220 includes a multi-channel (bio-signal) sensor unit 121 for sensing physiological signals of a human body that are formed during the reaction of the autonomic nervous system, for example, Photoplethysmography (PPG), Galvanic Skin Response (GSR), Skin Conductivity (SC), and Skin Temperature (ST) signals, an emotional signal processing unit 222 for processing the sensed signals, an emotional sensed information management unit 223 for analyzing and managing the processed emotional signals, and an emotional factor extraction unit 223 for extracting factors required to provide emotion recognition from the sensed information.

The multi-channel environment signal sensing unit 230 includes a multi-channel (environment signal) sensor unit 231 for sensing environment and context signals such as illumination, temperature/humidity, location, time, and images, an environment signal processing unit 232 for processing the sensed environment signals, an environmental sensed information management unit 233 for analyzing and managing the processed environment signals, a spatial emotional factor extraction unit 234 for extracting factors required for space and context emotion recognition from the sensed information, and the like.

In this way, the multi-channel bio-signal sensing unit 220 and the multi-channel environment signal sensing unit 230 may be operated in conjunction with the emotion recognition device 110 and may be attached to or detached from the emotion recognition device 110.

The emotion recognition management unit 240 receives the emotional factors sensed by and extracted from the multi-channel bio-signal sensing unit 220, receives spatial emotional factors sensed by and extracted from the multi-channel environment signal sensing unit 230, and recognizes and manage the danger and criminal emotions based on the received emotional factors.

The danger/criminal emotion recognition management unit 240 includes a multi-bio-signal-based emotional signal analysis unit 241, a danger emotion threshold management unit 242, a criminal emotion threshold management unit 243, a smart CCTV interworking unit 244, a location recognition unit 245, an image information reception unit 246, an image information analysis unit 247, a context awareness and context information management unit 248, and a danger/criminal emotion fusion reasoning unit 249. The multi-bio-signal-based emotional signal analysis unit 241 analyzes information required to provide emotion recognition based on bio-signals sensed via multiple channels. The danger emotion threshold management unit 242 defines and manages a threshold for a danger emotion. The criminal emotion threshold management unit 243 defines and manages a threshold for a criminal emotion. The smart CCTV interworking unit 244 aggregates information about an object being tracked from a smart CCTV to accurately recognize dangerous and criminal situations. The location recognition unit 245 recognizes a location at which a situation occurs.

The image information reception unit 246 receives image information about the object being tracked from the smart CCTV. The image information analysis unit 247 analyzes the received image information. The context awareness and context information management unit 248 manages bio-information, environment information, and image information. The danger/criminal emotion fusion reasoning unit 249 recognizes a danger emotion and a criminal emotion based on the bio-information, environment information, and context information.

The dangerous/criminal situation action unit 250 takes actions against dangerous and criminal situations based on the results of the recognition received from the emotion recognition management unit 240.

The dangerous/criminal situation action unit 250 includes a situation handling processing unit 251 for operating in conjunction with the smart CCTV, a warning situation processing unit 252 for providing notification of dangerous/criminal situations, a location tracking management unit 253 for tracking the location of the object in cooperation with the smart CCTV, a smart CCTV control unit 254 capable of controlling the smart CCTV in light of situation levels or the like, a personal protection management apparatus interworking unit 255 for coping with cases in cooperation with the personal protection management apparatus 130 in consideration of the emergency levels or the like of the cases, a situation automatic recording unit 256 for automatically recording image information received from the smart CCTV, and image and voice signals sensed by the emotion recognition device 110, a dangerous situation automatic message sending unit 257 for notifying an acquaintance or a family of a dangerous situation, and a dangerous situation automatic reporting unit 258 for reporting a dangerous situation by calling emergency numbers, e.g., 911 and the like.

Further, the dangerous and criminal situation action unit 250 is configured to activate, depending on the danger or criminal emotion, any one of a warning situation processing unit configured to output a warning sound; a location tracking management unit configured to track a real-time location; a recording unit configured to record images and sounds for a situation taking place in a scene; and an automatic message sending unit 257 configured to notify an acquaintance or a family of a dangerous situation, and an automatic reporting unit 258 configured to report a dangerous situation by calling emergency numbers.

FIG. 3 is a block diagram showing the detailed configuration of the image and sensor control apparatus in accordance with an embodiment of the present invention.

Referring to FIG. 3, the emotion recognition-based image and sensor control apparatus 120 may include an interworking unit 310 which operates in conjunction with the emotion recognition device 110 and the personal protection management apparatus 130, a sensing unit 320 which senses image signals and context information via object tracking, and a processing unit 330 which processes and controls the sensed information.

The interworking unit 310 includes a device interworking unit 311 for managing interworking with the emotion recognition device 110, a device message processing unit 312 for receiving an object tracking request or the like from the emotion recognition device 110 and transmitting tracked information, and a personal protection management apparatus interworking unit 313 for exchanging information with the personal protection management apparatus 130.

The sensing unit 320 may include an image signal sensing unit 321 for sensing image signals of an object being tracked, a temperate/humidity sensing unit 322 for sensing the surrounding temperature and humidity of each smart CCTV, an illumination sensing unit 323 for sensing the surrounding illumination of each smart CCTV, an object tracking unit 324 for controlling cooperative tracking between smart CCTVs for object tracking, an environmental multi-information analysis unit 325 for processing and analyzing sensed environment signals, an image signal analysis unit 326 for processing and analyzing sensed image signals, and the like.

The processing unit 330 may include an image signal management unit 331 for managing the analyzed image information and converting the image information into messages, an environment signal management unit 332 for managing analyzed environment information and converting the environment information into messages, a device message sending unit 333 for sending the image information and the environment information to the emotion recognition device 110, a danger emotion CCTV control unit 334 for controlling each smart CCTV upon receiving information about the recognition of a danger emotion, a criminal emotion CCTV control unit 335 for controlling the smart CCTV upon receiving information about the recognition of a criminal emotion, a CCTV control interface unit 336 for performing cooperative object tracking and operating in conjunction with the emotion recognition device 110 and the personal protection management apparatus 130, and the like.

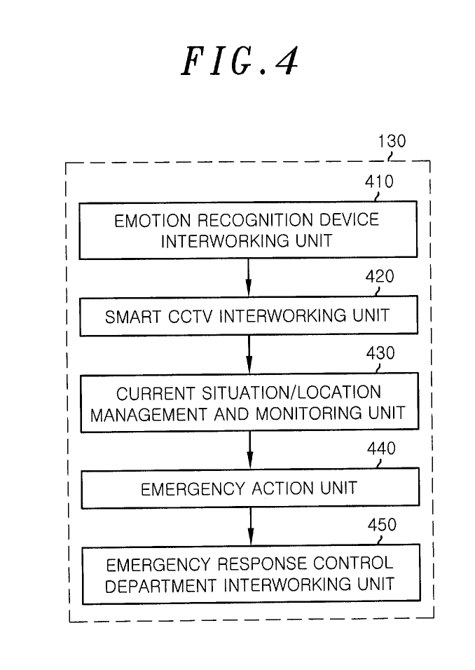

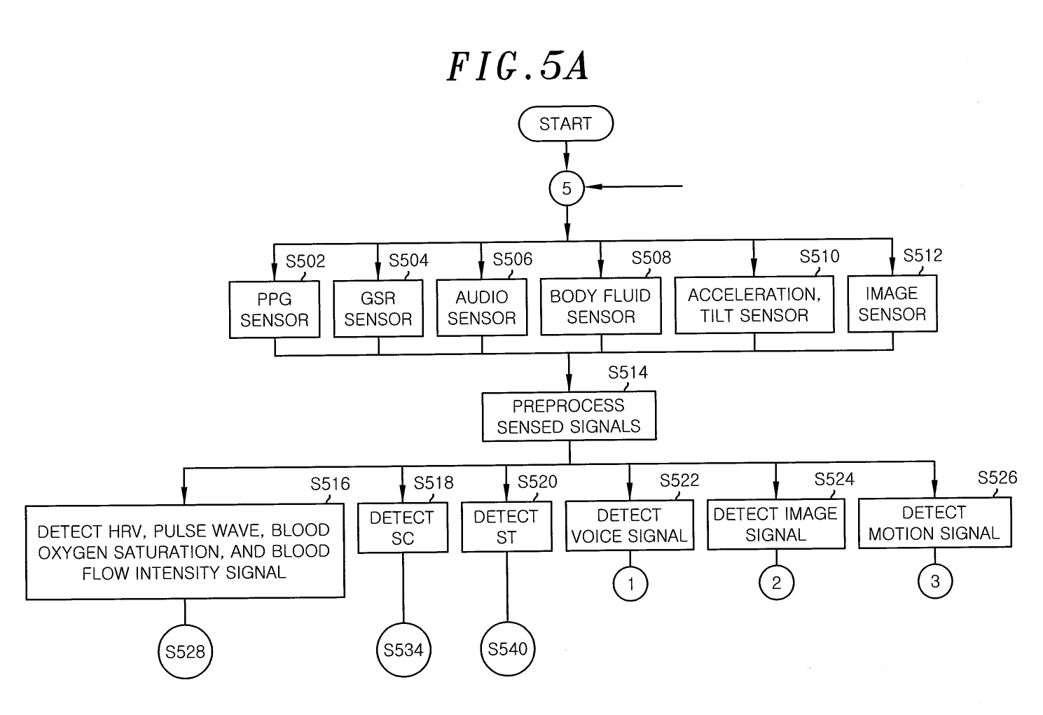

FIG. 4 is a block diagram showing the detailed configuration of the personal protection management apparatus in accordance with an embodiment of the present invention.

Referring to FIG. 4, the personal protection management apparatus 130 includes an emotion recognition device interworking unit 410, an image and sensor control apparatus interworking unit 420, a current situation/location management and monitoring unit 430, an emergency action unit 440, and an emergency response control department interworking unit 450.

The emotion recognition device interworking unit 410 interworks with the emotion recognition device 110. The image and sensor control apparatus interworking unit 420 interworks with the image and sensor control apparatus 120. Further, the current situation/location management and monitoring unit 430 performs location management and monitoring for a current situation, and analyzes at least one of environment information, bio-information, voice information, and image information, which have been received from the emotion recognition device, and images and location tracking information, which have been received from the image and sensor control apparatus.

Furthermore, the emergency action unit 440 takes actions in case of an emergency. Specifically, the emergency action unit 440, if it is determined as a result of the analysis that a danger or criminal emotion has been recognized, sends a message requesting generation of a warning sound to the emotion recognition device and transmits a request for an emergency of the object to a department which controls dangers and crimes. Further, the emergency response control department interworking unit 450 connects a call to emergency numbers, e.g., “911”.

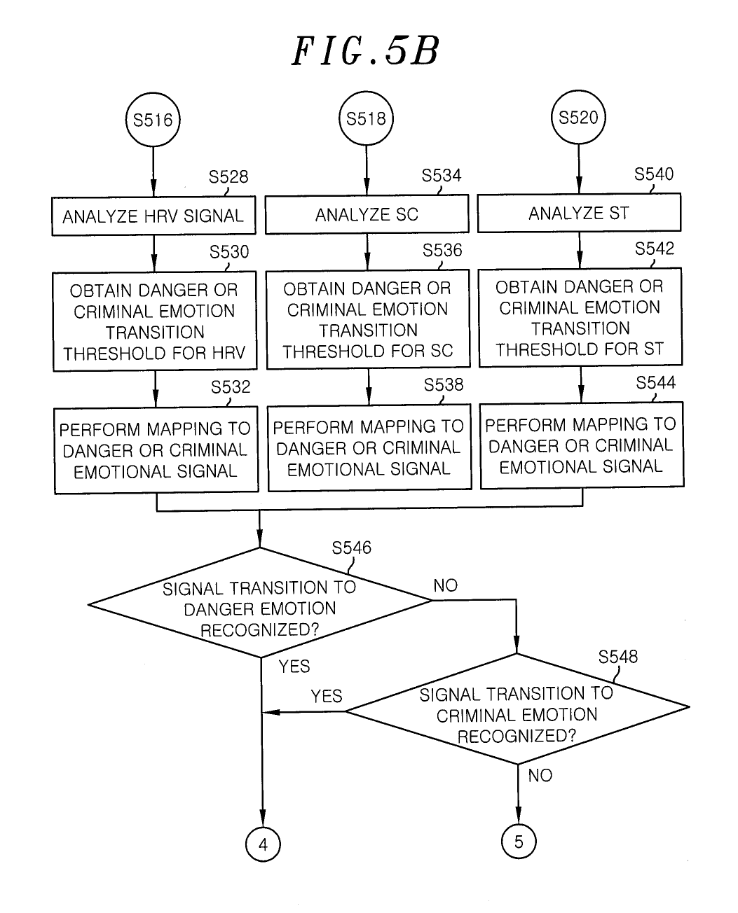

FIGS. 5A to 8B are flow charts showing the operating procedure of the emotion recognition device in accordance with an embodiment of the present invention.

Referring to FIGS. 5A and 5B, the emotion recognition device 110 senses signals such as blood oxygen saturation, a pulse rate, and an electrocardiogram (ECG) using a photoplethysmographic (PPG) sensor or an ECG sensor in step S502, senses a skin conductivity (SC) signal and a skin temperature (ST) signal using a Galvanic Skin Response (GSR) sensor in step S504, senses voice/sound waves using an acoustic sensor such as a microphone in step S506, senses body fluids such as blood, sweat, and spit using a body fluid sensor in step S508, senses motions using an acceleration sensor and a tilt sensor in step S510, and recognizes images using an image sensor such as an optical camera in step S512.

That is, steps S502 to S512 are not sequentially performed, and the respective steps of performing sensing in the multi-channel bio-signal sensing unit 220 and the multi-channel environment signal sensing unit 230 are performed non-sequentially.

First, the procedure of recognizing danger and criminal emotions based on bio-signals which are obtained using the PPG sensor (or ECG sensor) in step S502 or using the body fluid sensor in step S508 is performed. Then, the function of preprocessing the signals sensed by the respective sensors is performed by the emotional signal processing unit 222 and the environment signal processing unit 232 in step S514. Further, the emotional factor extraction unit 224 detects signals, such as Heart Rate Variability (HRV), a pulse wave, blood oxygen saturation, and blood flow intensity, from refined signals in the function of post-processing the sensed PPG, ECG and body fluid signals, in step S516. The detected signals are transferred to the emotion recognition management unit 240.

The multi-bio-signal-based emotional signal analysis unit 241 of the emotion recognition management unit 240 analyzes the signals, such as the HRV, pulse wave, blood oxygen saturation, and blood flow intensity, in step S528. Further, in step S530, danger emotion transition thresholds and criminal emotion transition thresholds for the respective detected signals are obtained by the danger emotion threshold management unit 242 and the criminal emotion threshold management unit 243. The mapping of the detected signals to a danger emotional signal or a criminal emotional signal is performed in step S532.

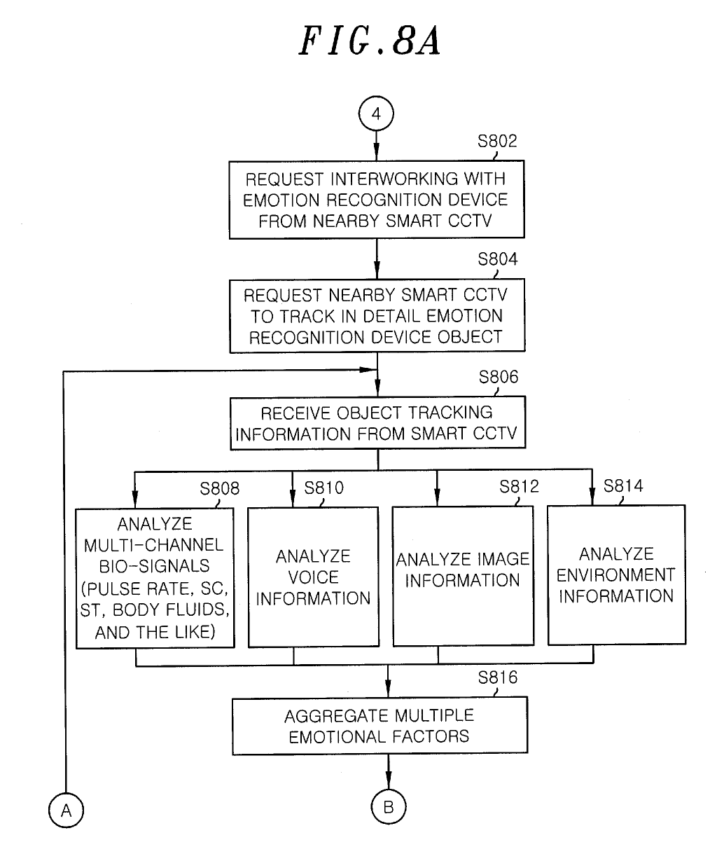

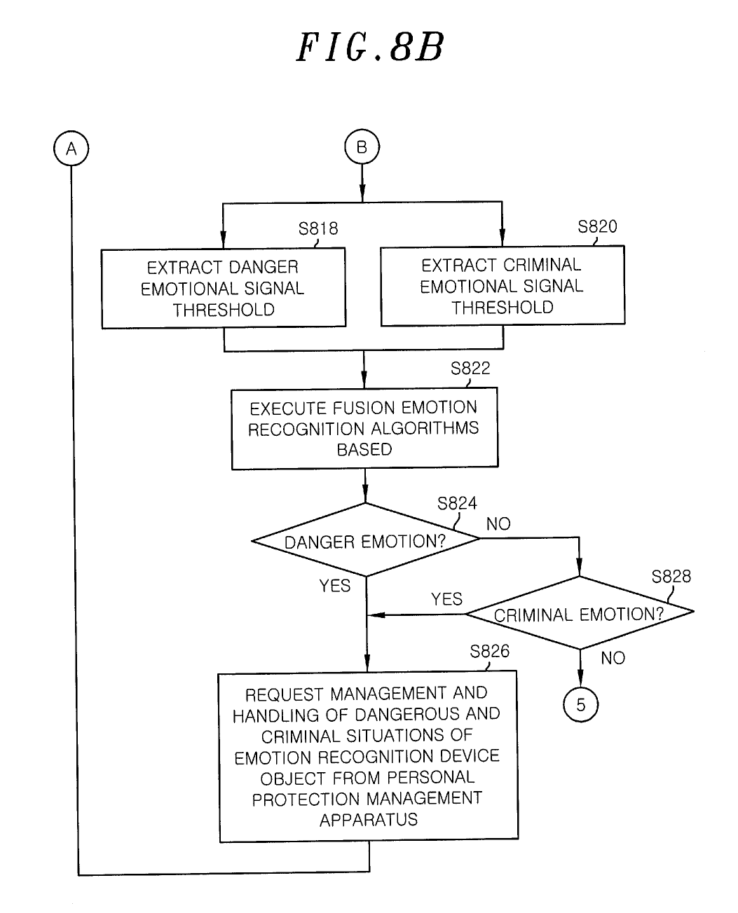

Thereafter, in step S546, it is determined whether a signal transition to a danger emotion has been recognized. If the signal transition to the danger emotion has been recognized, the dangerous/criminal situation action unit 250 of the emotion recognition device 110 sends an interworking request message to a nearby smart CCTV, that is, the image and sensor control apparatus 120 in step S802, and sends a message requesting the detailed tracking of an object corresponding to the owner of the emotion recognition device 110 in step S804, as shown in FIG. 8A.

Thereafter, the emotion recognition device 110 is operated in information aggregation mode in which information about the object being tracked is aggregated from the smart CCTV. When information about the object being tracked is received from the smart CCTV in step S806, operations such as the analysis of multiple bio-signals in step S808, the analysis of voice information in step S810, the analysis of image information in step S812, and the analysis of environment information in step S814 are performed, and then the operation of extracting and aggregating multiple emotional factors is performed in step S816.

Further, the danger emotion threshold management unit 242 and the criminal emotion threshold management unit 243 extract optimal thresholds of danger emotional signals for relevant multiple signals in step S818, and extracts optimal thresholds of criminal emotional signals in step S820. The danger/criminal emotion fusion reasoning unit 249 executes a danger emotion fusion awareness algorithm and a criminal emotion fusion awareness algorithm that are based on multiple emotional signals in step S822.

Thereafter, in step S824, when the emotions recognized by the danger/criminal emotion fusion reasoning unit 249 are examined, and a danger emotion is recognized, a message requesting the management and handling of the dangerous situation of the object corresponding to the emotion recognition device 110 is sent to the personal protection management apparatus 130 in step S826.

Thereafter, the process returns to step S806 to repeat the operations of tracking the object and determining whether danger and criminal emotions have been recognized in steps S806 to S826. When an emotion recognition termination request message is received from the user via the danger/criminal emotion recognition device UI 210, the process is terminated.

Meanwhile, if it is determined in step S824 that a danger emotion has not been recognized, the process proceeds to the step 828 of determining whether a criminal emotion has been recognized. If it is determined that the criminal emotion has been recognized, the process proceeds to step 826 at which a message requesting the management and handling of the criminal situation of the object corresponding to the bodyguard device is sent to the personal protection management apparatus 130.

Further, the process returns to step S806 to repeat the operations of tracking the object and determining whether danger and criminal emotions have been recognized in steps S806 to S826. When an emotion recognition termination request message is received from the user via the danger/criminal emotion recognition device UI 210, the process is terminated.

However, if it is determined in step S828 that the criminal emotion has not been recognized, the process returns to step S502 in FIG. 5A to repeat steps S502 to S548 in FIGS. 5A and 5B, and steps S802 to S828 in FIGS. 8A and 8B. When an emotion recognition termination request message is received from the user via the danger/criminal emotion recognition device UI 210, the process is terminated.

Meanwhile, if a signal transition to a danger emotion has not been recognized in step S546, the process proceeds to step 548 at which it is determined whether a signal transition to a criminal emotion has been recognized. If it is determined that the signal transition to the criminal emotion has been recognized, steps 802 to 828 in FIG. 8 are repeatedly performed. When an emotion recognition termination request message is received from the user via the danger/criminal emotion recognition device UI 210, the process is terminated.

In contrast, if it is determined in step S548 that the signal transition to the criminal emotion has not been recognized, the process returns to step S502 of FIG. 5.

Meanwhile, if the function of preprocessing signals sensed by the GSR sensor is performed in step S514 in the procedure of recognizing danger and criminal emotions in signals sensed from the skin using the GSR sensor in step S504 in FIG. 5, a Skin Conductivity (SC) signal is detected from refined signals in the function of post-processing GSR signals in step S518.

The SC signal is analyzed in step S534, a danger emotion transition threshold and a criminal emotion transition threshold are obtained for the relevant SC signal in step S536, and the function of mapping the relevant SC signal to a danger emotional signal or a criminal emotional signal is performed in step S538.

Thereafter, in step S546, it is determined whether a signal transition to a danger emotion has been recognized in the SC signal. If it is determined that the signal transition to the danger emotion has been recognized, the process proceeds to the step 802 of FIG. 8 at which the emotion recognition device (bodyguard device) sends an interworking request message to a nearby smart CCTV, and sends a message requesting the detailed tracking of an object corresponding to the owner of the emotion recognition device 110 in step S804. If object tracking information is received from the smart CCTV in step S806, the operations of extracting and aggregating multiple emotional factors are performed in step S808 to S814.

After the above procedure, in step S818 and S820, optimal thresholds of danger emotional signals for relevant multiple signals are extracted. In step S822, a danger emotion fusion awareness algorithm and a criminal emotion fusion awareness algorithm that are based on multiple emotional signals are executed, thus determining, based on reasoning, whether a danger emotion and a criminal emotion have been recognized.

In step S824, the determined emotion is examined, so that if a danger emotion has been recognized, a message requesting the management and handling of the dangerous/criminal situations of the object corresponding to the emotion recognition device 110 is sent to the personal protection management apparatus 130 in step S826. Then the process returns to step S806.

Thereafter, the operations of tracking the object and determining whether danger and criminal emotions have been recognized in steps S806 to S826 are repeated. When an emotion recognition termination request message is received from the user via the danger/criminal emotion recognition device UI 210, the process is terminated.

Meanwhile, if it is determined in step S824 that a danger emotion has not been recognized, the process proceeds to step 828 at which it is determined whether a criminal emotion has been recognized. If it is determined that the criminal emotion has been recognized, the process proceeds to step 826 at which a message requesting the management and handling of the criminal situation of the object corresponding to the bodyguard device is sent to the personal protection management apparatus 130.

In contrast, if it is determined in step S828 that the criminal emotion has not been recognized, the process returns to step S502 in FIG. 5 to repeat steps S502 to S548 and steps 802 to 828 in FIG. 8. When an emotion recognition termination request message is received from the user via the danger/criminal emotion recognition device UI 210, the process is terminated.

Further, when signals are sensed from the skin through the GSR sensor in step S504, the function of preprocessing the sensed signals is performed in step S514, and a skin temperature (ST) signal is detected from refined signals in the function of post-processing GSR signals in step S520.

Then, the ST signal is analyzed in step S540, a danger emotion transition threshold and a criminal emotion transition threshold for the ST signal are obtained in step S542, and the function of mapping the ST signal to a danger emotional signal or a criminal emotional signal is performed in step S544.

Thereafter, in step S546, it is determined whether a signal transition to a danger emotion has been recognized in the ST signal. In step S548, it is determined whether a signal transition to a criminal emotion has been recognized in the ST signal.

Therefore, if it is determined that the signal transition to the danger emotion or the criminal emotion has been recognized, the operations of tracking the object and determining whether danger and criminal emotions have been recognized are repeated in steps S806 to S826. When an emotion recognition termination request message is received from the user via the danger/criminal emotion recognition device UI 210, the process is terminated.

In contrast, if it is determined that the signal transition to the danger emotion or the criminal emotion has not been recognized, the process returns to steps S502 to S512 in FIG. 5.

Meanwhile, if the function of preprocessing signals sensed by an audio sensor, for example, a microphone, is performed in step S514 in the procedure of recognizing danger and criminal emotions based on voice signals using the audio sensor in step S506 in FIG. 5, voice signals are detected from refined signals in the function of post-processing microphone signals in step S522.

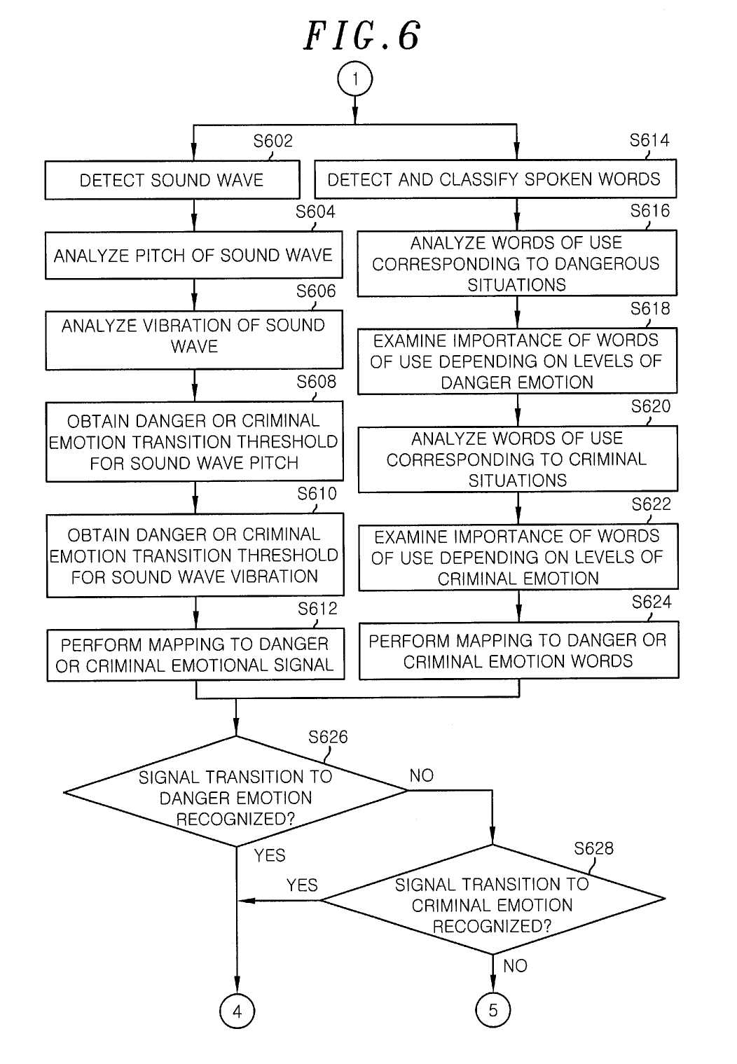

Thereafter, in step S602 in FIG. 6, a tone and a sound wave are detected from the voice signals, and spoken words are detected in step S614. Respective steps can be processed in parallel, and an operation performed when a tone and a sound wave are detected is described first. That is, when a tone and a sound wave are detected in step S602, the pitch of the sound wave is analyzed in step S604, and the vibration of the sound wave is analyzed in step S606. Further, in step Ss 608 and 610, danger emotion transition thresholds and criminal emotion transition thresholds for the pitch and vibration of the sound wave are obtained, and the function of mapping the obtained signals to a danger emotional signal or a criminal emotional signal is performed in step S612.

Further, in step S614 in FIG. 6, when spoken words are detected from the user's voice, that is, voice signals, are detected, the words are classified. Thereafter, in step S616, the words of use corresponding to dangerous situations are analyzed, and in step S618, the importance of the words of use ranked per the level of the danger emotion is examined. Furthermore, in step S620, words of use corresponding to criminal situations are analyzed. In step S622, the importance of the words of use ranked per the level of the criminal emotion is examined. In step S624, the function of mapping the words of use to words for the danger emotion or for the criminal emotion is performed.

After mapping has been performed in step S612 and S624, it is determined whether a signal transition to the danger emotion or the criminal emotion has been recognized in the mapped signals in step S626 and S628. Here, if it is determined that the signal transition to the danger emotion or the criminal emotion has been recognized, the operations of tracking the object and determining whether danger and criminal emotions have been recognized are repeated in steps S806 to S826. When an emotion recognition termination request message is received from the user via the danger/criminal emotion recognition device UI 210, the process is terminated.

Meanwhile, when signals are sensed by an image sensor, for example, an optical camera, in step S512 in FIG. 5 in the procedure of recognizing danger and criminal emotions based on image signals, the function of preprocessing the sensed signals is performed in step S514. Image signals are detected from refined signals in the function of post-processing signals from the optical camera in step S524.

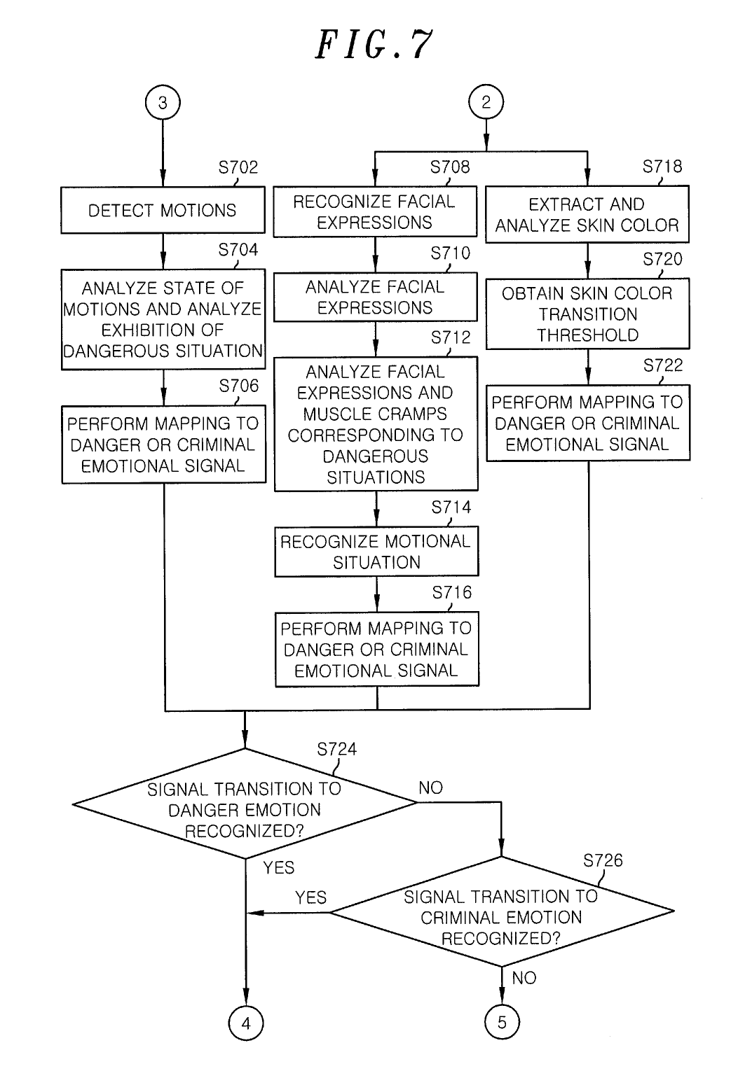

Thereafter, in step S708 in FIG. 7, the emotion recognition device 110 extracts the facial expressions of the user. In step S718, the skin color of the user is extracted and analyzed. That is, steps 708 and 718 may be performed in parallel, and the procedure of extracting the user's facial expressions is described first. The extracted facial expressions are analyzed in step S710.

Then, in step S712, it is determined whether facial expressions and muscle cramps corresponding to dangerous situations have been exhibited based on the results of the analysis of the facial expressions. Further, in step S714, the image signals are analyzed, so that motions or the like corresponding to dangerous situations are recognized based on motional situations.

By means of this procedure, in step S716, mapping to a danger emotional signal or a criminal emotional signal is performed using the analyzed facial expressions, muscle cramps, motion information, and the like. After the mapping has been performed, it is determined whether a signal transition to a danger emotion or a criminal emotion has been recognized in the mapped signals in step S724 and S726. Here, if it is determined that the signal transition to the danger emotion or the criminal emotion has been recognized, the operations of tracking the object and determining whether danger and criminal emotions have been recognized are repeated in steps S806 to S826. When an emotion recognition termination request message is received from the user via the danger/criminal emotion recognition device UI 210, the process is terminated.

Meanwhile, when signals are sensed by an acceleration sensor and a tilt sensor in step S510 in FIG. 5 in the procedure of recognizing danger and criminal emotions via the analysis of motions based on the acceleration sensor, the function of preprocessing the sensed signals is performed in step S514. Motion signals are detected from refined signals in the function of post-processing acceleration and tilt signals.

Thereafter, in step S702 in FIG. 7, motions are detected. In step S704, the status of the motions is analyzed, and it is determined whether motion intensities and motion types corresponding to dangerous situations have been exhibited. Further, in step S706, mapping to a danger emotional signal or a criminal emotional signal is performed based on the results of the determination.

After mapping has been performed, it is determined whether a signal transition to a danger emotion or a criminal emotion has been recognized in the mapped signals in step S724 and S726. Therefore, if it is determined that a signal transition to the danger emotion or the criminal emotion has been recognized, the operations of tracking the object and determining whether danger and criminal emotions have been recognized are repeated in steps S806 to S826. When an emotion recognition termination request message is received from the user via the danger/criminal emotion recognition device UI 210, the process is terminated.

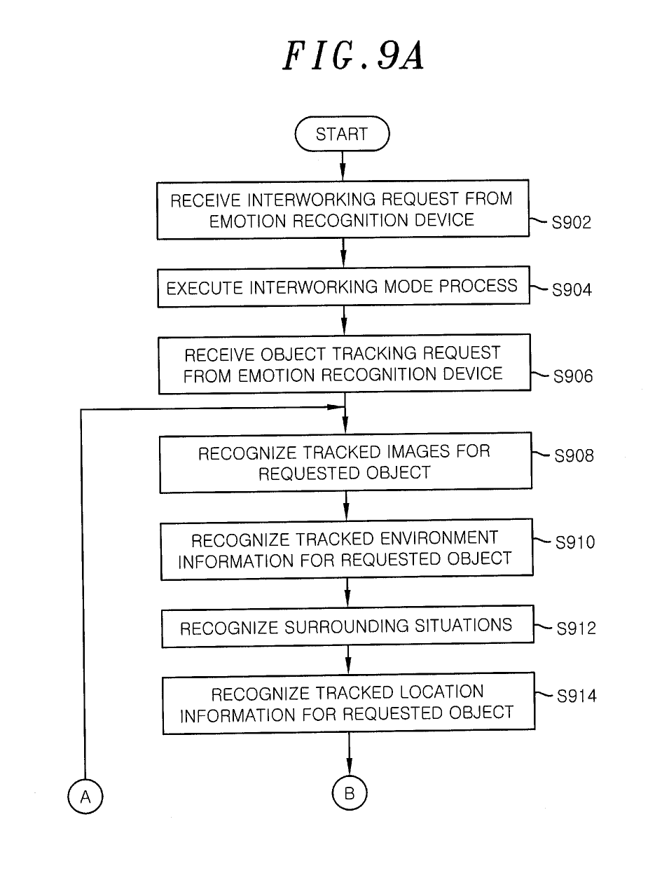

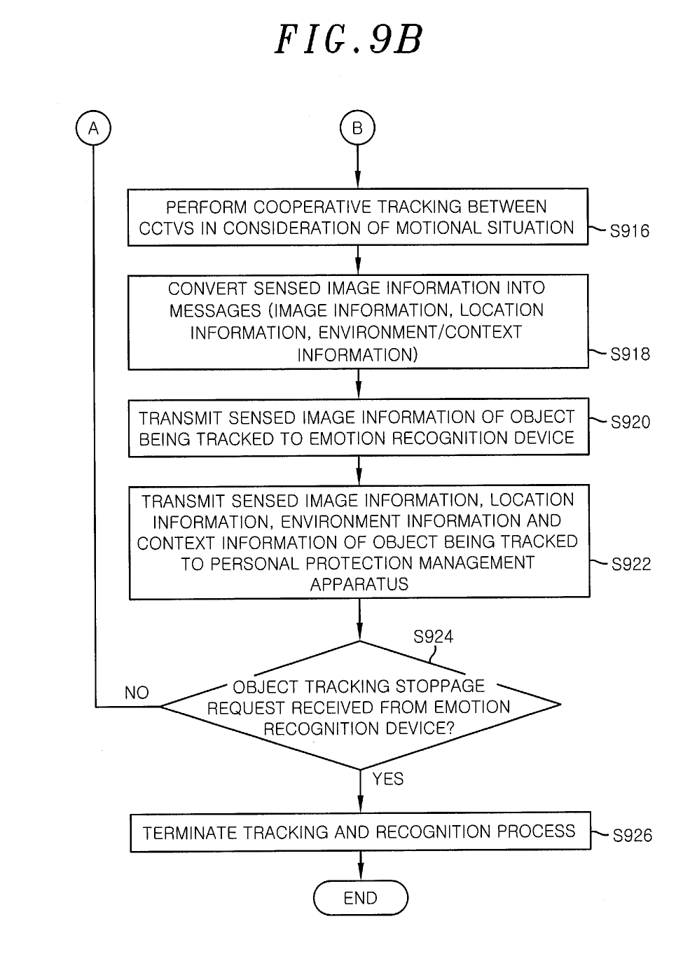

FIGS. 9A and 9B are flow charts showing the operating procedure of the image and sensor control apparatus in accordance with an embodiment of the present invention.

Referring to FIGS. 9A and 9B, when the image and sensor control apparatus 120, which can be operated in conjunction with the emotion recognition-based bodyguard device, that is, the emotion recognition device 110, receives an interworking request message from the emotion recognition device 110 in step S902, the apparatus 120 switches the current mode to interworking mode with the emotion recognition device 110 via the interworking unit 310, and executes a tracking monitoring process corresponding to a relevant object via the sensing unit 320 in step S904.

Thereafter, when an object tracking request message is received in step S906, the recognition of images is performed by tracking the requested object via the sensing unit 320 in step S908. Further, in step S910, information about an environment in which the object being tracked is located is recognized, and in step S912, image information required to recognize surrounding situations is also aggregated.

In step S914, location information about the requested object is continuously tracked. In step S916, the processing unit 330 tracks the object in cooperation with other image and sensor control apparatuses in consideration of the motional situation of the object. In step S918, pieces of image signal information sensed with respect to the corresponding object being tracked (for example, image information, location information, environment information, context information, and the like) are converted into messages. In step S920, the sensed information is transmitted to the emotion recognition device 110.

Further, in step S922, the pieces of information sensed with respect to the corresponding object being tracked, that is, the image information, the location information, and the context information, are transmitted to the personal protection management apparatus 330. Thereafter, in step S924, it is determined whether a message requesting the stoppage of the tracking and monitoring of the corresponding object has been received from the emotion recognition device 110. If it is determined that such a message has been received, the process proceeds to step 926 at which the process for tracking and recognizing (monitoring) the corresponding object is terminated.

However, if it is determined in step S924 that the message requesting the stoppage of the tracking and monitoring of the corresponding object has not been received from the emotion recognition device 110, the object tracking operations in steps S908 to S924 are repeated until the message requesting the stoppage of the tracking and monitoring of the object is received.

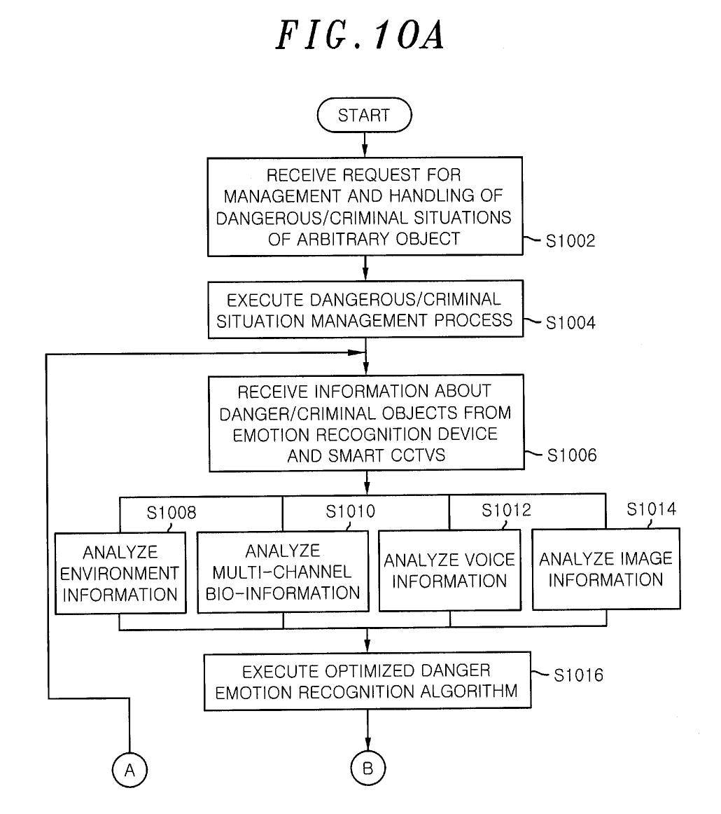

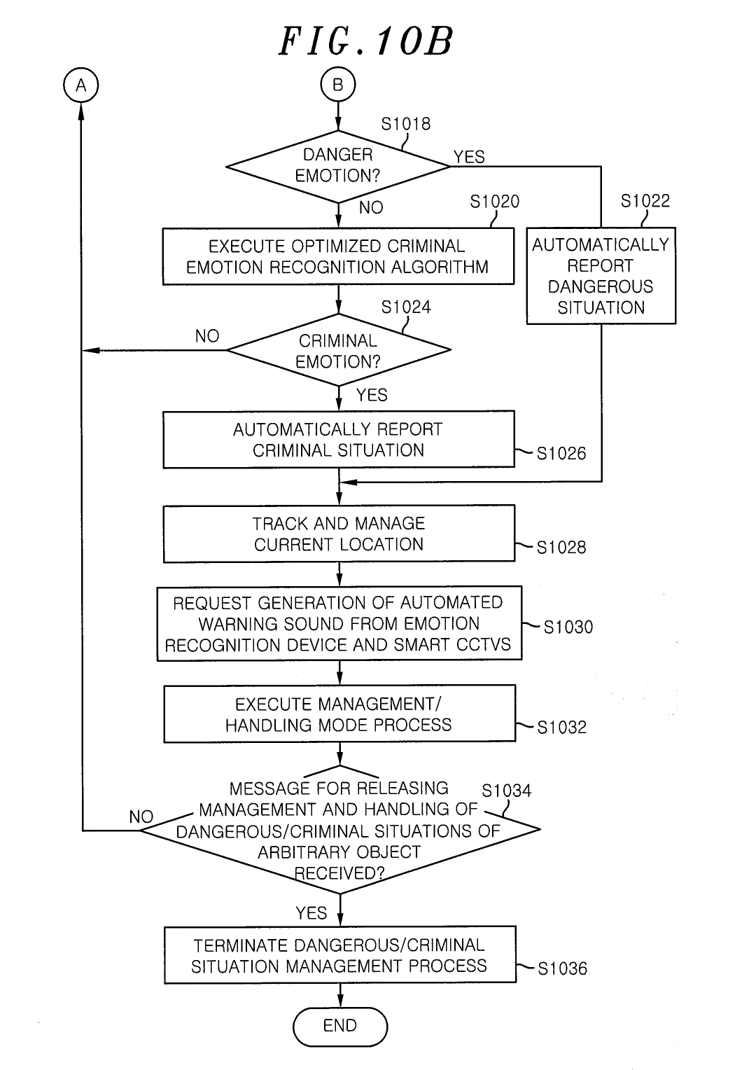

FIGS. 10A and 10B are flow charts showing the operating procedure of the personal protection management apparatus in accordance with an embodiment of the present invention.

Referring to FIGS. 10A and 10B, the personal protection management apparatus 130 is operated in conjunction with a plurality of emotion recognition devices 110 and a plurality of image and sensor control apparatuses (smart CCTVs) 120. In step S1002, when a message requesting the management and handling of dangerous/criminal situations of an arbitrary object is received from an emotion recognition device 110 for which a danger emotion and a criminal emotion have been determined to be recognized, a management process for the corresponding object is executed in step S1004.

In step S1006, pieces of information about danger/criminal objects are received from the emotion recognition device 110 and the image and sensor control apparatuses 120. Operations such as the analysis of environment information in step S1880, the analysis of multi-channel bio-information in step S1010, the analysis of voice information in step S1012, and the analysis of image information in step S1014, are performed as a precise and accurate analysis procedure for the pieces of received information. The respective analysis procedures are performed either sequentially or in parallel. At least one analysis procedure is performed depending on the management of the situation of each relevant object.

Thereafter, in step S1016, an optimized danger emotion recognition algorithm is executed based on all the pieces of information received from the emotion recognition device 110 and the image and sensor control apparatuses 120 via the current situation/location management and monitoring unit 430.

In this case, in step S1018, it is determined whether a danger emotion has been recognized. If it is determined that the danger emotion has been recognized, a dangerous situation is automatically reported via the emergency response control department interworking unit 450 in step S1022, and the operation of tracking the current location of the relevant object and managing the current situation is performed in step S1028.

Thereafter, in step S1030, a request for the generation of an automated warning sound is transmitted both to the emotion recognition device 110 and to the image and sensor control apparatuses 120. In step S1032, a management/handling mode process is executed. Further, in step S1034, it is determined whether a message for releasing the management and handling of the dangerous/criminal situations of the relevant object has been received from the emotion recognition device 110. If it is determined that the release message has been received, the process proceeds to step 1036 at which the process for managing dangerous/criminal situations is terminated.

In contrast, if it is determined in step S1034 that the message for releasing the management and handling of the dangerous/criminal situations of the relevant object has not been received, the process returns to step S1006 to repeat steps S1006 to S1032.

Meanwhile, if it is determined in step S 1018 that the danger emotion has not been recognized, the process proceeds to step 1020 at which an optimized criminal emotion recognition algorithm is executed. Further, in step S 1024, it is determined whether a criminal emotion has been recognized. If it is determined that the criminal emotion has been recognized, the process proceeds to step 1026 at which the criminal situation is automatically reported. In step S1028, the operation of tracking the current location of the object and managing the current situation is performed.

Thereafter, in step S1030, a request for the generation of an automated warning sound is transmitted both to the emotion recognition device 110 and to the image and sensor control apparatuses 120. In step S1032, a management/handling mode process is executed. Further, in step S1034, if a message for releasing the management and handling of the dangerous/criminal situations of the relevant object has been received from the emotion recognition device 110, the process proceeds to step 1036 at which the process for managing dangerous/criminal situations is terminated.

In contrast, in step S1034, if the message for releasing the management and handling of dangerous/criminal situations of the relevant object has not been received, the process returns to step S1006 to repeat steps S1006 to S1032.

As described above, the emotion recognition-based bodyguard system, emotion recognition device, image and sensor control apparatus, personal protection management apparatus and control methods thereof in accordance with embodiments of the present invention are intended to prevent or automatically handle a dangerous situation or a criminal act by recognizing a danger emotion and a criminal emotion among emotional responses to situations encountered by a user in daily life, and are configured to prevent and automatically handle a dangerous or criminal situation via the control of and interworking with a bodyguard device, smart CCTVs, and the personal protection management device, wherein the bodyguard device is capable of recognizing a danger emotion and a criminal emotion based on both emotional signal awareness information, obtained by sensing bio-signals formed during the reaction of a human being's autonomic nervous system, and context awareness information, obtained by sensing environment signals, and that is capable of controlling the smart CCTVs and operating in conjunction with the smart CCTVs based on the recognized danger and criminal emotions.

As described above, the emotion recognition-based bodyguard system, the emotion recognition device, the image and sensor control apparatus, the personal protection management apparatus, and control methods thereof in accordance with the embodiments of the present invention have the following one or more advantages.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An emotion recognition device comprising:
a user interface configured to display input-related menus and receive a control command;
a sensing unit configured to sense a bio-signal of a user or a surrounding environment signal of the user using at least one sensor;
an emotion recognition management unit configured to determine based on the sensed signal whether a transition to a danger emotional signal or a criminal emotional signal for the user has occurred, and then requesting tracking emotion recognition; and
a dangerous and criminal situation action unit configured to request emotion recognition handling of a dangerous or criminal situation depending on a danger or criminal emotion.

2. The emotion recognition device of claim 1, wherein the sensing unit comprises:
a bio-signal sensing unit configured to sense the bio-signal using at least one of a photoplethysmography (PPG) sensor, an electrocardiogram (ECG) sensor, a Galvanic Skin Response (GSR) sensor, a Skin Conductivity (SC) sensor, a Skin Temperature (ST) sensor, an audio sensor, and a body fluid sensor and then extract an emotional factor; and
an environment signal sensing unit configured to sense the surrounding environment signal of the user using at least one of a temperature sensor, a humidity sensor, an illumination sensor, an image sensor, an acceleration sensor, and a tilt sensor, and then extract a spatial emotional factor.

3. The emotion recognition device of claim 1, wherein the emotion recognition management unit is configured to:
analyze a sensed signal corresponding to at least one of blood flow, SC, ECG, voice, image, and motion signals and determine whether a transition of the corresponding signal to the danger or criminal emotional signal has occurred, based on a threshold,
if the transition to the danger or criminal emotional signal has been recognized, request performing of tracking and receiving object tracking information, and
determine whether a danger or criminal emotion has been recognized using preset danger and criminal emotion algorithms, based on the analyzed and received information.

4. The emotion recognition device of claim 3, wherein the emotion recognition management unit analyzes and extracts a pitch and vibration of a sound wave based on the sensed voice signal, and analyzes and extracts spoken words from the voice signal.

5. The emotion recognition device of claim 3, wherein the emotion recognition management unit analyzes whether a facial expression of the user has changed based on the sensed image signal, and analyzes whether a skin color of the user has changed based on the image signal.

6. The emotion recognition device of claim 1, wherein the dangerous and criminal situation action unit is configured to activate, depending on the danger or criminal emotion, any one of:
a warning situation processing unit configured to output a warning sound;
a location tracking management unit configured to track a real-time location;
a recording unit configured to record images and sounds for a situation taking place in a scene; and
an automatic message sending unit configured to notify an acquaintance or a family of a dangerous situation, and an automatic reporting unit configured to report a dangerous situation by calling emergency numbers.

7. An image and sensor control apparatus comprising:
an interworking unit configured to receive an object tracking request message emotion recognition;
a sensing unit configured to recognize an image of an object requested to be tracked, sense a surrounding environment and track a location of the object; and
a processing unit configured to transmit the recognized image, sensed surrounding environment information, and location tracking information emotion recognition.

8. A personal protection management apparatus comprising:
an emotion recognition device interworking unit configured to interwork with the emotion recognition device which senses a bio-signal and a surrounding environment signal and recognizes danger and criminal emotions; an image and sensor control apparatus interworking unit configured to interwork with an emotion recognition device which aggregates image and location information by tracking an object requested by the emotion recognition device;
a current situation/location management and monitoring unit configured to, when receiving information about the object from the emotion recognition device and the image and sensor control apparatus, analyze the received information and execute danger and criminal emotion recognition algorithms; and
an emergency action unit configured to, if it is determined as a result of the analysis that a danger or criminal emotion has been recognized, send a message requesting generation of a warning sound to the emotion recognition device and transmit a request for an emergency of the object to a department which controls dangers and crimes.

9. The personal protection management apparatus of claim 8, wherein the monitoring unit analyzes at least one of environment information, bio-information, voice information, and image information, which have been received from the emotion recognition device, and images and location tracking information, which have been received from the image and sensor control apparatus.

10. An emotion recognition-based bodyguard system comprising:
an emotion recognition device configured to receive an emotional signal by sensing a bio-signal of a user and to receive context information by sensing a surrounding environment signal of the user, thus determining whether a danger emotion and a criminal emotion have been recognized based on a threshold;
an image and sensor control apparatus configured to, upon receiving an object tracking request from the emotion recognition device which operates in conjunction with the image and sensor control apparatus, sense an image signal and surrounding environment information, track a relevant object based on location information of the relevant object, and transmit tracking-related information about the relevant object to the emotion recognition device; and
a personal protection management apparatus configured to receive a message requesting management and handle situations in conjunction with the emotion recognition device and the image and sensor control apparatus, analyze information about the relevant object, and, if it is determined that a danger emotion or a criminal emotion has been recognized, report a current situation to an emergency response department, perform tracking a location of the relevant object, and monitoring the object.

11. A method for controlling an emotion recognition device, comprising:
sensing, by a sensing unit, a bio-signal of a user or a surrounding environment signal of the user using at least one sensor;
determining, by an emotion recognition management unit, whether a transition to a danger emotional signal or a criminal emotional signal for the user has occurred, based on the sensed signal, and then sending a tracking request message emotion recognition; and
sending, by an action unit, a message requesting handling of a dangerous or criminal situation emotion recognition.

12. The method of claim 11, wherein said sensing comprises:
sensing the bio-signal of the user using at least one of a photoplethysmography (PPG) sensor, an electrocardiogram (ECG) sensor, a Galvanic Skin Response (GSR) sensor, a Skin Conductivity (SC) sensor, a Skin Temperature (ST) sensor, an audio sensor, and a body fluid sensor and then extracting an emotional factor; and
sensing the surrounding environment signal of the user using at least one of a temperature sensor, a humidity sensor, an illumination sensor, an image sensor, an acceleration sensor, and a tilt sensor, and then extracting a spatial emotional factor.

13. The method of claim 11, wherein said sending the tracking request message comprises;
analyzing a sensed signal corresponding to at least one of blood flow, SC, ST, voice, image, and motion signals and determining whether a transition of the corresponding signal to the danger or criminal emotional signal has occurred, based on a threshold;
if the transition to the danger or criminal emotional signal has been recognized, requesting performing of tracking and receiving object tracking information; and
determining whether a danger or criminal emotion has been recognized using preset danger and criminal emotion algorithms, based on the analyzed and received information.

14. The method of claim 13, wherein said determining based on the threshold is configured to analyze and extract a pitch and vibration of a sound wave based on the sensed voice signal, and analyze and extract spoken words from the voice signal.

15. The method of claim 13, wherein said determining based on the threshold is configured to analyze whether a facial expression of the user has changed based on the sensed image signal, and analyze whether a skin color of the user has changed based on the image signal.

16. The method of claim 11, wherein said sending the message requesting the handling of the dangerous or criminal situation is configured to activate, depending on the danger or criminal emotion, one of a warning situation processing unit for outputting a warning sound, a location tracking management unit for tracking a real-time location, a recording unit for recording images and sounds for a situation taking place in a scene, and a control department interworking unit for sending a preset context message given a presence of dangerous and criminal situations, and reporting the situations to a control department.

17. A method for controlling an image and sensor control apparatus, comprising:
receiving, by an interworking unit, an object tracking request message emotion recognition and recognizing danger and criminal emotions;
recognizing, by a sensing unit, an image of an object requested to be tracked, sensing a surrounding environment and tracking a location of the object; and
transmitting, by a processing unit, the recognized image, sensed surrounding environment information, and location tracking information emotion recognition.

18. A method for personal protection management apparatus, comprising:
operating, by an interworking unit, in conjunction with an emotion recognition device which senses a bio-signal and a surrounding environment signal and recognizes danger and criminal emotions, and an image and sensor control apparatus which aggregates image and location information by tracking an object requested by the emotion recognition device;
when information about the object is received from the emotion recognition device and the image and sensor control apparatus, analyzing, by a monitoring unit, the received information and executing danger and criminal emotion recognition algorithms; and
if it is determined as a result of the analysis that a danger or criminal emotion has been recognized, sending, by an emergency action unit, a message requesting generation of a warning sound to the emotion recognition device and transmitting a request for an emergency of the object to a department which controls dangers and crimes.

19. The method of claim 18, wherein said executing the danger and criminal emotion recognition algorithms is configured to analyze at least one of environment information, bio-information, voice information, and image information, which have been received from the emotion recognition device, and images and location tracking information, which have been received from the image and sensor control apparatus.

20. An emotion recognition-based bodyguard method, comprising:
receiving, by an emotion recognition device, an emotional signal by sensing a bio-signal of a user;
receiving context information by sensing a surrounding environment signal of the user;
determining whether a danger emotion and a criminal emotion have been recognized based on a threshold;
when receiving an object tracking request from the emotion recognition device which operates in conjunction with an image and sensor control apparatus, sensing, by the image and sensor control apparatus, an image signal and surrounding environment information;
tracking a relevant object based on location information of the relevant object, and transmitting tracking-related information about the relevant object to the emotion recognition device;
receiving, by a personal protection management apparatus, a message requesting management and handling of situations in conjunction with the emotion recognition device and the image and sensor control apparatus;
analyzing information about the relevant object, and, if it is determined that a danger emotion or a criminal emotion has been recognized, reporting a current situation to an emergency response department; and
tracking a location of the relevant object and monitoring the object.
